(19) United States
(12) Patent Application Publication
(10) Pub. No.: US 2016/0312545 A1
(43) Pub. Date: Oct. 27, 2016

(54) DRILLING STABILIZER WITH SLEEVE OVER BLADES

(71) Applicant: SCHLUMBERGER TECHNOLOGY CORPORATION, Sugar Land, TX (US)

(72) Inventors: Stuart David Dixon Walker, Bristol (GB); Paul Michael Linford, Bristol (GB)

(21) Appl. No.: 15/090,745

(22) Filed: Apr. 5, 2016

Related U.S. Application Data
(60) Provisional application No. 62/150,805, filed on Apr. 21, 2015.

(51) Int. Cl. E21B 17/10; B23K 26/342; B23K 31/02

(52) U.S. Cl. CPC E21B 17/1078; B23K 31/02; B23K 26/342; B33Y 10/00

(57) ABSTRACT

A drilling stabilizer includes a plurality of blades configured to rotate about a longitudinal axis of the drill string and further includes a sleeve over the blades. The sleeve can form a barrier between the blades and an inner wall of the borehole.

### CROSS-REFERENCE TO RELATED APPLICATIONS

The present application claims the benefit under 35 U.S.C. §119(e) of U.S. Provisional Application Ser. No. 62/150,805, filed Apr. 21, 2015, and titled “DRILLING STABILIZER WITH SLEEVE FORMED OVER BLADES.” U.S. Provisional Application Ser. No. 62/150,805 is incorporated herein, by reference, in its entirety.

### BACKGROUND

Oil wells are created by drilling a hole into the earth, in some cases using a drilling rig that rotates a drill string (e.g., drill pipe) having a drill bit attached thereto. In other cases, the drilling rig does not rotate the drill bit. For example, the drill bit can be rotated downhole. When drilling into a soft formation (e.g., sea-bed drilling), drilling stabilizers can be used to avoid excessive damage to or “machining” of the formation.

### SUMMARY

Aspects of the disclosure can relate to a drilling stabilizer. The drilling stabilizer can include a drill collar configured to be removably coupled with a component of a drill string. A plurality of blades can be disposed about the drill collar. The drilling stabilizer can also include a sleeve over the plurality of blades.

Other aspects of the disclosure can be related to a drilling system. The drilling system can include a drill string and a plurality of blades configured to rotate about a longitudinal axis of the drill string while the drill string is lowered into or raised out of a bore hole. The drilling system can also include a sleeve over the plurality of blades. The plurality of blades can be bound by a diameter of the sleeve. The sleeve can be configured to form a barrier between the plurality of blades and an inner wall of the borehole.

Aspects of the disclosure can also relate to a method of producing a drilling stabilizer. The method can include provisioning a drill collar and forming blades about the drill collar. The method can further include attaching a sleeve to the blades formed about the drill collar.

This summary is provided to introduce a selection of concepts that are further described below in the detailed description. This summary is not intended to identify key or essential features of the claimed subject matter, nor is it intended to be used as an aid in limiting the scope of the claimed subject matter.

### FIGURES

Embodiments of a drilling stabilizer having a sleeve over its blades are described with reference to the following figures. The same numbers are used throughout the figures to reference like features and components.

FIG. 1 illustrates an example system in which embodiments of a drilling stabilizer can be implemented.

FIG. 2 is a perspective view of an example drilling stabilizer.

FIG. 3 is a perspective view of an example device that can implement a drilling stabilizer having a sleeve over its blades in accordance with embodiments of this disclosure.

FIG. 4 is an end view of an example device that can implement a drilling stabilizer having a sleeve over its blades in accordance with embodiments of this disclosure.

FIG. 5 is a side view of an example device that can implement a drilling stabilizer having a sleeve over its blades in accordance with embodiments of this disclosure.

FIG. 6 is a side view of an example device that can implement a drilling stabilizer having a sleeve over its blades in accordance with embodiments of this disclosure.

FIG. 7 is a side view of an example device that can implement a drilling stabilizer having a sleeve over its blades in accordance with embodiments of this disclosure.

FIG. 8 is a flow diagram illustrating an example process for producing a drilling stabilizer.

### DETAILED DESCRIPTION

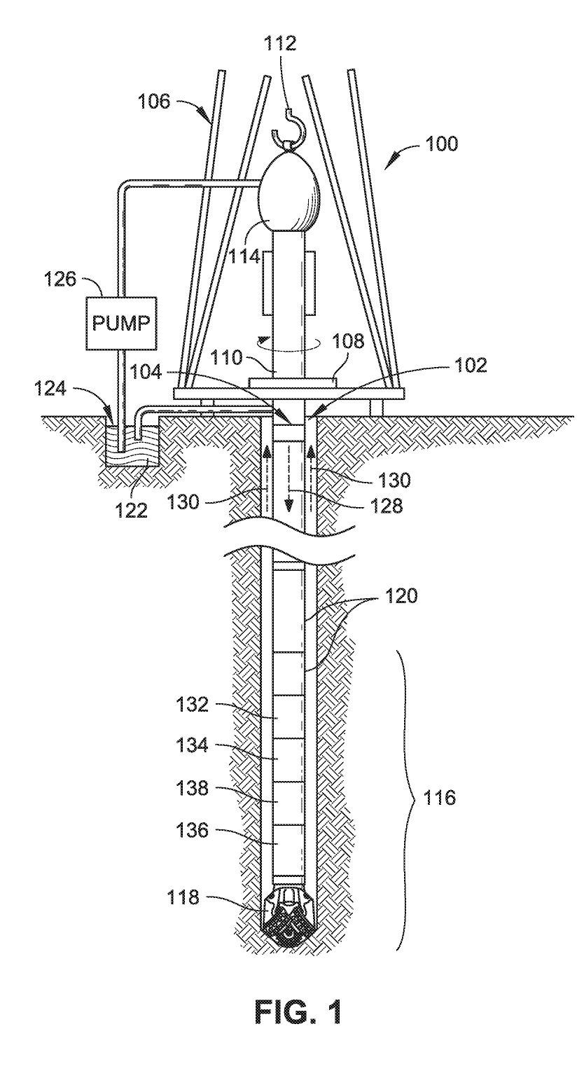

FIG. 1 depicts a wellsite system 100 in accordance with one or more embodiments of the present disclosure. The wellsite can be onshore or offshore. A borehole 102 is formed in subsurface formations by directional drilling. A drill string 104 extends from a drill rig 106 and is suspended within the borehole 102. In some embodiments, the wellsite system 100 implements directional drilling using a rotary steerable system (RSS). For instance, the drill string 104 is rotated from the surface, and down hole devices move the end of the drill string 104 in a desired direction. The drill rig 106 includes a platform and derrick assembly positioned over the borehole 102. In some embodiments, the drill rig 106 includes a rotary table 108, kelly 110, hook 112, rotary swivel 114, and so forth. For example, the drill string 104 is rotated by the rotary table 108, which engages the kelly 110 at the upper end of the drill string 104. The drill string 104 is suspended from the hook 112 using the rotary swivel 114, which permits rotation of the drill string 104 relative to the hook 112. However, this configuration is provided by way of example and is not meant to limit the present disclosure. For instance, in other embodiments a top drive system is used.

A bottom hole assembly (BHA) 116 is suspended at the end of the drill string 104. The bottom hole assembly 116 includes a drill bit 118 at its lower end. In embodiments of the disclosure, the drill string 104 includes a number of drill pipes 120 that extend the bottom hole assembly 116 and the drill bit 118 into subterranean formations. Drilling fluid (e.g., mud) 122 is stored in a tank and/or a pit 124 formed at the wellsite. The drilling fluid can be water-based, oil-based, and so on. A pump 126 displaces the drilling fluid 122 to an interior passage of the drill string 104 via, for example, a port in the rotary swivel 114, causing the drilling fluid 122 to flow downwardly through the drill string 104 as indicated by directional arrow 128. The drilling fluid 122 exits the drill string 104 via ports (e.g., courses, nozzles) in the drill bit 118, and then circulates upwardly through the annulus region between the outside of the drill string 104 and the wall of the borehole 102, as indicated by directional arrows 130. In this manner, the drilling fluid 122 cools and lubricates the drill bit 118 and carries drill cuttings generated by the drill bit 118 up to the surface (e.g., as the drilling fluid 122 is returned to the pit 124 for recirculation).

In some embodiments, the bottom hole assembly 116 includes a logging-while-drilling (LWD) module 132, a measuring-while-drilling (MWD) module 134, a rotary steerable system 136, a motor, and so forth (e.g., in addition to the drill bit 118). The logging-while-drilling module 132 can be housed in a drill collar and can contain one or a number of logging tools. It should also be noted that more than one LWD module and/or MWD module can be employed (e.g., as represented by another logging-while-drilling module 138). In embodiments of the disclosure, the logging-while drilling modules 132 and/or 138 include capabilities for measuring, processing, and storing information, as well as for communicating with surface equipment, and so forth.

The measuring-while-drilling module 134 can also be housed in a drill collar, and can contain one or more devices for measuring characteristics of the drill string 104 and drill bit 118. The measuring-while-drilling module 134 can also include components for generating electrical power for the down hole equipment. This can include a mud turbine generator (also referred to as a “mud motor”) powered by the flow of the drilling fluid 122. However, this configuration is provided by way of example and is not meant to limit the present disclosure. In other embodiments, other power and/or battery systems can be employed. The measuring-while-drilling module 134 can include one or more of the following measuring devices: a weight-on-bit measuring device, a torque measuring device, a vibration measuring device, a shock measuring device, a stick slip measuring device, a direction measuring device, an inclination measuring device, and so on.

In embodiments of the disclosure, the wellsite system 100 is used with controlled steering or directional drilling. For example, the rotary steerable system 136 is used for directional drilling. As used herein, the term “directional drilling” describes intentional deviation of the wellbore from the path it would naturally take. Thus, directional drilling refers to steering the drill string 104 so that it travels in a desired direction. In some embodiments, directional drilling is used for offshore drilling (e.g., where multiple wells are drilled from a single platform). In other embodiments, directional drilling enables horizontal drilling through a reservoir, which enables a longer length of the wellbore to traverse the reservoir, increasing the production rate from the well. Further, directional drilling may be used in vertical drilling operations. For example, the drill bit 118 may veer off of a planned drilling trajectory because of the unpredictable nature of the formations being penetrated or the varying forces that the drill bit 118 experiences. When such deviation occurs, the wellsite system 100 may be used to guide the drill bit 118 back on course.

Drill assemblies can be used with, for example, a wellsite system (e.g., the wellsite system 100 described with reference to FIG. 1). For instance, a drill assembly can comprise a bottom hole assembly suspended at the end of a drill string (e.g., in the manner of the bottom hole assembly 116 suspended from the drill string 104 depicted in FIG. 1). In some embodiments, a drill assembly is implemented using a drill bit. However, this configuration is provided by way of example and is not meant to limit the present disclosure. In other embodiments, different working implement configurations are used. Further, use of drill assemblies in accordance with the present disclosure is not limited to wellsite systems described herein. Drill assemblies can be used in other various cutting and/or crushing applications, including earth boring applications employing rock scraping, crushing, cutting, and so forth.

A drill assembly includes a body for receiving a flow of drilling fluid. The body comprises one or more crushing and/or cutting implements, such as conical cutters and/or bit cones having spiked teeth (e.g., in the manner of a roller-cone bit). In this configuration, as the drill string is rotated, the bit cones roll along the bottom of the borehole in a circular motion. As they roll, new teeth come in contact with the bottom of the borehole, crushing the rock immediately below and around the bit tooth. As the cone continues to roll, the tooth then lifts off the bottom of the hole and a high-velocity drilling fluid jet strikes the crushed rock chips to remove them from the bottom of the borehole and up the annulus. As this occurs, another tooth makes contact with the bottom of the borehole and creates new rock chips. In this manner, the process of chipping the rock and removing the small rock chips with the fluid jets is continuous. The teeth intermesh on the cones, which helps clean the cones and enables larger teeth to be used. A drill assembly comprising a conical cutter can be implemented as a steel milled-tooth bit, a carbide insert bit, and so forth. However, roller-cone bits are provided by way of example and are not meant to limit the present disclosure. In other embodiments, a drill assembly is arranged differently. For example, the body of the bit comprises one or more polycrystalline diamond compact (PDC) cutters that shear rock with a continuous scraping motion.

In embodiments of the disclosure, the body of a drill assembly can define one or more nozzles that allow the drilling fluid to exit the body (e.g., proximate to the crushing and/or cutting implements). The nozzles allow drilling fluid pumped through, for example, a drill string to exit the body. For example, drilling fluid can be furnished to an interior passage of the drill string by the pump and flow downwardly through the drill string to a drill bit of the bottom hole assembly, which can be implemented using, for example, a drill assembly. Drilling fluid then exits the drill string via nozzles in the drill bit, and circulates upwardly through the annulus region between the outside of the drill string and the wall of the borehole. In this manner, rock cuttings can be lifted to the surface, destabilization of rock in the wellbore can be at least partially prevented, the pressure of fluids inside the rock can be at least partially overcome so that the fluids do not enter the wellbore, and so forth.

In embodiments, the system 100 can further include a drilling stabilizer (e.g., coupled to or included within the BHA 116). Drilling stabilizers are sometimes used to mechanically stabilize the BHA 116 or other portions of the drill string within the borehole to prevent unintentional sidetracking, vibrations, and ensure the quality of the hole being drilled. In some embodiments, two or more stabilizers may be fitted into the BHA 116. For example, a (near-bit) stabilizer can be positioned just above the drill bit 118 and/or a (string) stabilizer can be positioned higher up the drill string (e.g., among the drill collars).

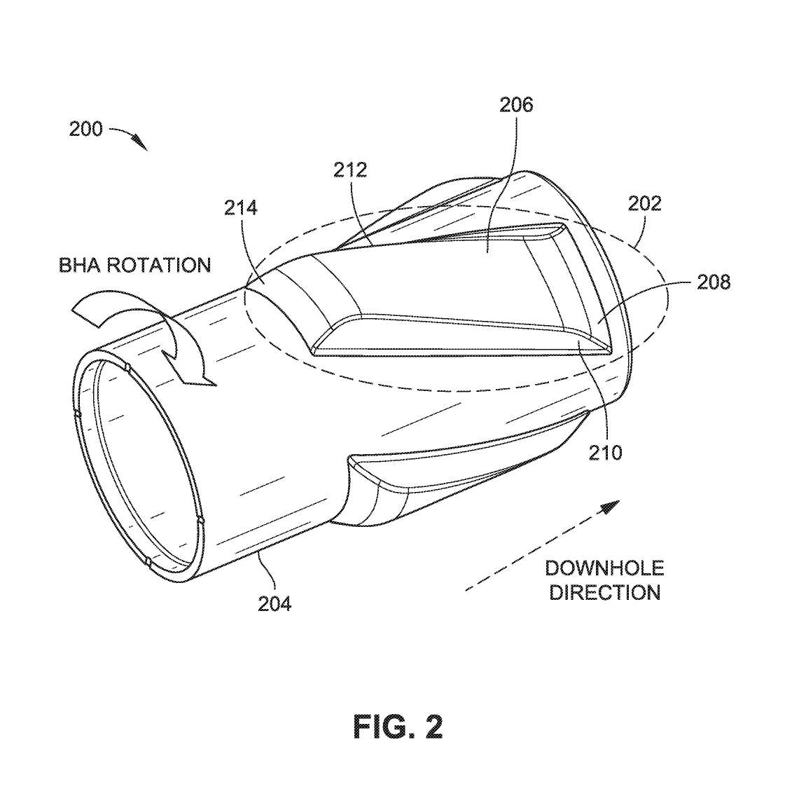

FIG. 2 shows an example of a drilling stabilizer 200. The drilling stabilizer 200 includes collar 204 with a plurality of blades 202 formed about its perimeter. Each blade 202 has a leading face 208, a trailing face 214, a leading edge 210, and a trailing edge 212. These features allow the blades 202 to move fluid (e.g., mud) and cuttings along while the drilling stabilizer 200 is rotated through the hole being drilled. Each blade 202 has a high contact area crown 206 to prevent or reduce machining of the hole by unintentional sidetracking, vibrations, and so forth. However, the scraping motion of the edges 210 and 212 of each blade 200 as it rotates against the borehole can still result in unintentional machining despite the high contact area of the crown 206. This is exacerbated when blades with less than 360 degree wrap are used because a line contact may be made between an edge (e.g., edge 210 and/or 212) of the blade 200 and the borehole, thereby increasing contact stress.

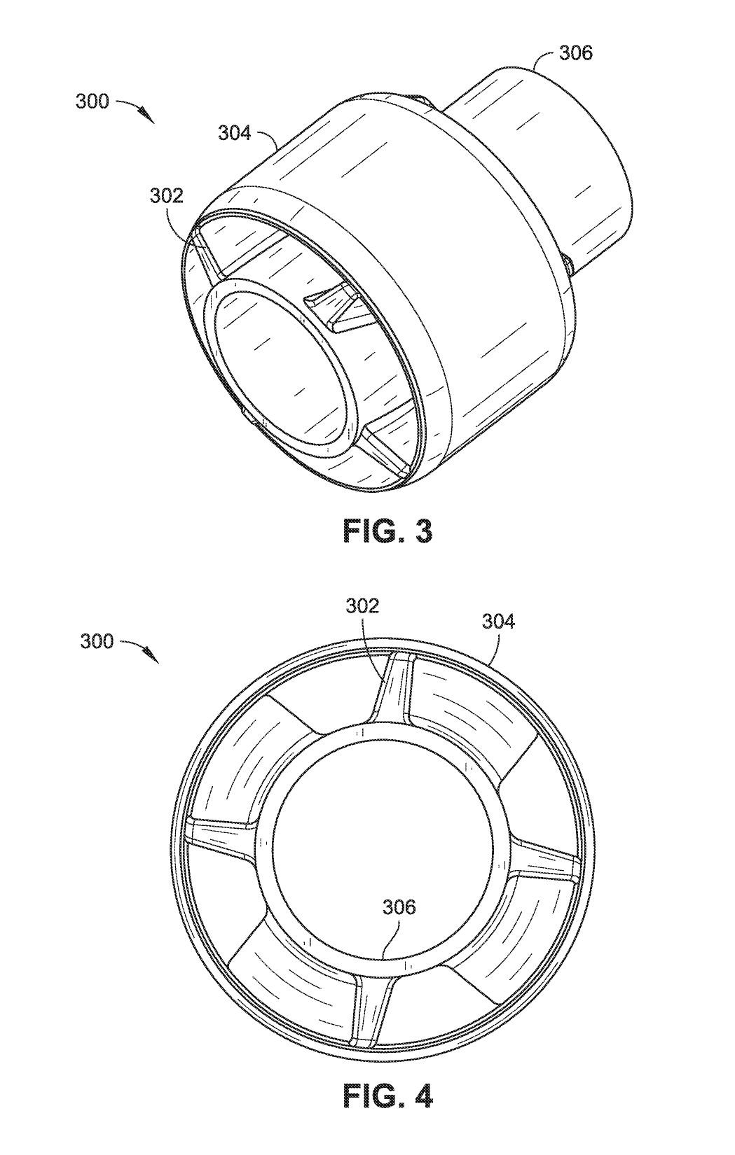

A drilling stabilizer 300 is shown in FIGS. 3 through 7 in accordance with various embodiments of this disclosure. It has been found that with traditional stabilizers, such as the stabilizer 200 shown in FIG. 2, there is a trade-off between contact area (crown or blade width) and flow area (or “junk slot” area) between the blades. Looking now to FIG. 3, embodiments of stabilizer 300 can include thin blades 302 having wide junk slots between them and a large (e.g., continuous or nearly continuous) contact surface 304 (e.g., an outer sleeve) over the blades 302 (e.g., formed over the blades) in order to reduce contact stress that can be caused by lateral forces on the BHA 116 (e.g., gravity, directional steering, or vibration). Suitable fluid flow can be achieved while avoiding potential damage to a borehole formation which would otherwise result from the thin blades 302 or struts making repetitive contact with an inner wall of the borehole formation.

As shown in FIGS. 3 through 7, the drilling stabilizer 300 may include struts or blades 302 which can be coupled to a drill collar 306. In some implementations, the drill collar 306 may be removably coupled or configured to be removably coupled to the drill string (e.g., coupled to a component of the BHA 116 or another portion of the drill string). For example, the drill collar 306 may include fasteners, cooperative threading, engagement ports, or the like, that enable the drill collar 306 to be selectively coupled to portions of the drill string or other components of the drill string (e.g., coupled to other drill collars, intermediate connectors, or the like). The blades 302 and the drill collar 306 may be machined from a common block of material, or the blades 302 can be welded to the drill collar 306, or may be formed on the drill collar 306 using a three-dimensional manufacturing (sometimes referred to as “additive manufacturing”) technology, such as laser cladding or the like.

The blades 302 can be configured to rotate about a longitudinal axis of a drill string. In some embodiments, the blades 302 can rotate with the drill string. In other embodiments, the drill collar 306 can include bearings that allow the blades 302 to rotate about the drill string or at a different rotational rate than the drill string. For example, the drill collar 306 may include an inner tubular member and an outer tubular member formed around the inner tubular member, with bearings (e.g., ball bearings) in between the inner and outer tubular members, the blades 302 being formed on the outer tubular member.

The blades 302 can extend to an outer sleeve 304 that is configured to form a barrier between the blades 302 and an inner wall of a borehole. In embodiments, the sleeve 304 has a continuous or nearly continuous surface and is configured to contact the inner wall of the borehole while the blades 302 are rotating, thereby preventing the blades 302 themselves from making repetitive high pressure contact with the inner wall and potentially damaging the borehole formation. In some embodiments, the stabilizer 300 can have a suitably large sleeve diameter as compared to the drill collar diameter to ensure that there remains sufficient flow area between the outer sleeve 304 and the attachment collar 306.

In embodiments, an outer surface of the sleeve 304 can include protective hardfacing, such as tungsten carbide tiles, thermally stable polycrystalline (TSP) diamond inserts, tungsten carbide laser cladding, or the like. Hardfacing can be applied using a tungsten carbide matrix infiltration technique. Additional examples of protective hardfacing (e.g., “wear protection elements 52”) are provided in U.S. Patent App. Pub. No. 2015/0275589, which is hereby incorporated by reference in its entirety. The blades 302 may be thin or slender for improved flow area, yet strong enough to support the outer sleeve 304. For example, a thickness of a blade may be less than a distance between the blade and a neighboring blade. In some embodiments, the blades 302 can also have protective hardfacing on them to resist erosion (e.g., wear from cuttings in mud or fluid passing through blades). Where the blades 302 are slender, it can be advantageous to build the blades 302 up by laser cladding or other three-dimensional printing or manufacturing technology instead of extensively machining a solid block of material. Additionally, laser cladding may incorporate protective hardfacing for the blades 302. Profiling of the blades 302 (e.g., aerofoil cross-section) may reduce the drag or pressure drop further to help transport of cuttings and reduce erosion. In some embodiments, the blades 302 may follow a helical or straight/longitudinal trajectory. Helical blades can reduce the drag on the fluid in a rotating assembly, while straight blades can reduce drag when tripping in/out of the borehole without rotating. Other fins or features can also be added to help dislodge any trapped cuttings.

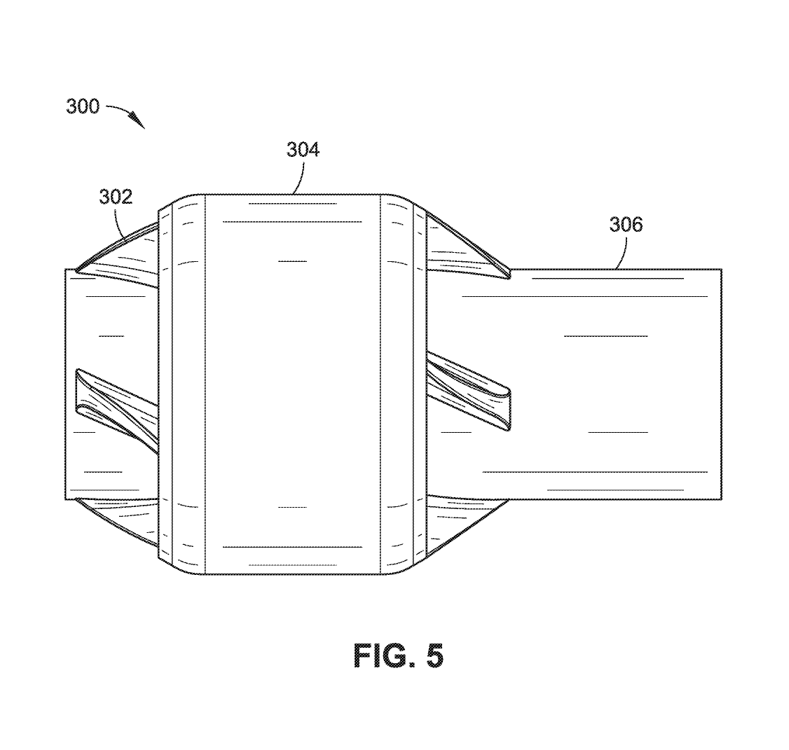

In embodiments, the blades 302 may be partially exposed (e.g., as shown in FIG. 5). The exposed portions may be within a boundary defined by an outer diameter of the sleeve 304. For example, the blades 302 may extend longitudinally but not laterally beyond the sleeve 304. In some embodiments, the exposed portions of the blades 302 can include long tapered ends that may help prevent “hanging” on a ledge or washout in the formation. As shown in FIG. 5, the sleeve 304 can also be tapered at one or both ends to match up with a profile of the blades 302. Shallow lead-in and radius to the outer-diameter of the sleeve 304 can prevent cutting the formation with a leading face of the blades.

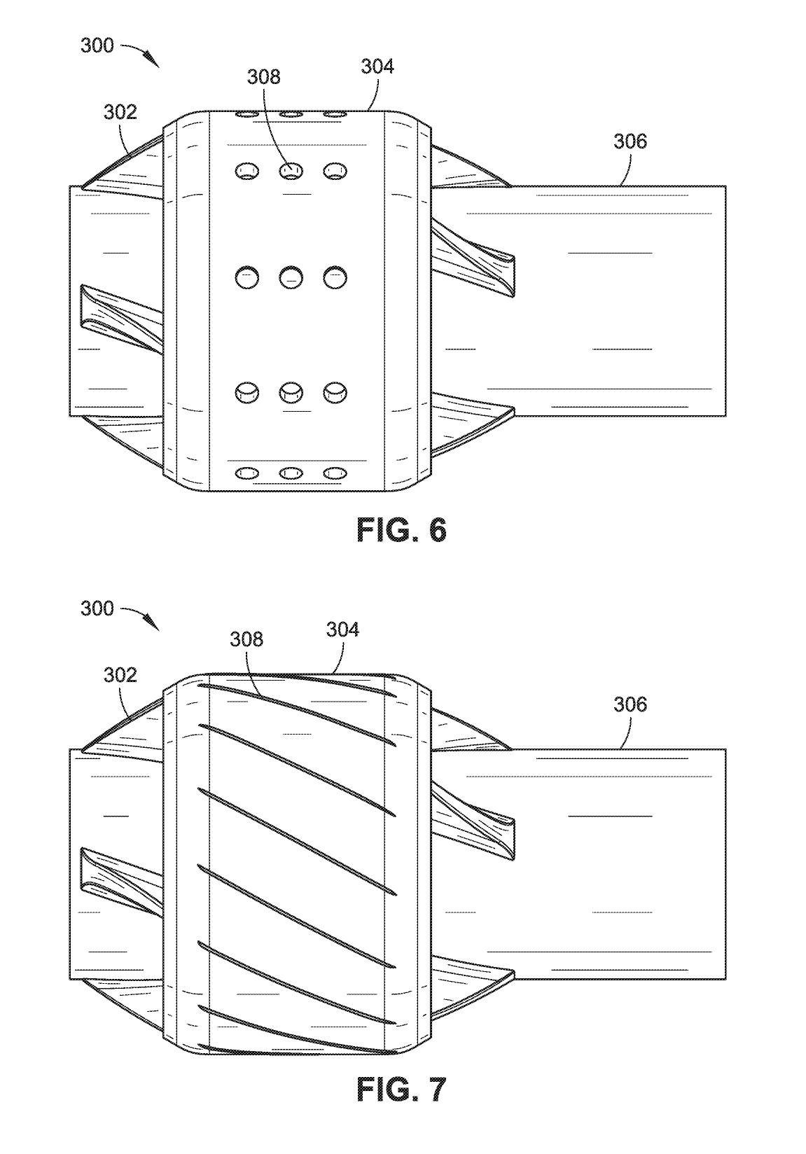

In some embodiments, e.g., as shown in FIGS. 6 and 7, the sleeve 304 can include relief openings 308 formed in a lateral surface of the sleeve 304. The openings 308 may enable fluid to flow through or along the lateral surface of the sleeve in order to prevent differential sticking. Differential sticking can occur when the borehole pressure is higher than the formation pressure. If the pipe or any other surface is stationary and in contact with an inner wall of the borehole, then the pressure can press the surface to the inner wall, generating enough friction to become stuck. The openings 308 can prevent a large pressure drop across the surfaces. For example, the openings 308 can include holes to allow the fluid to pass through the surface (e.g., as shown in FIG. 6), or helical or longitudinal grooves allowing fluid to migrate along the surface (e.g., as shown in FIG. 7).

In some embodiments, the sleeve 304 may not be continuous around the blades 302. For example, the sleeve 304 can be discontinuous at one or more locations. In some embodiments, the sleeve 304 can include a curved panel formed over the blades 302, where the ends of the panel do not come into contact with one another. For example, the sleeve 304 may include a panel that forms about 50-60%, 60-70%, 70-80%, 80-90%, or 90-99% of a circle around the blades. In other embodiments, the sleeve 304 includes two or more disjoined portions, where at least one of the disjoined portions is coupled to two or more blades 302. For example, the sleeve 304 can include a plurality of curved panels, where each panel is formed over a respective subset of the blades 302.

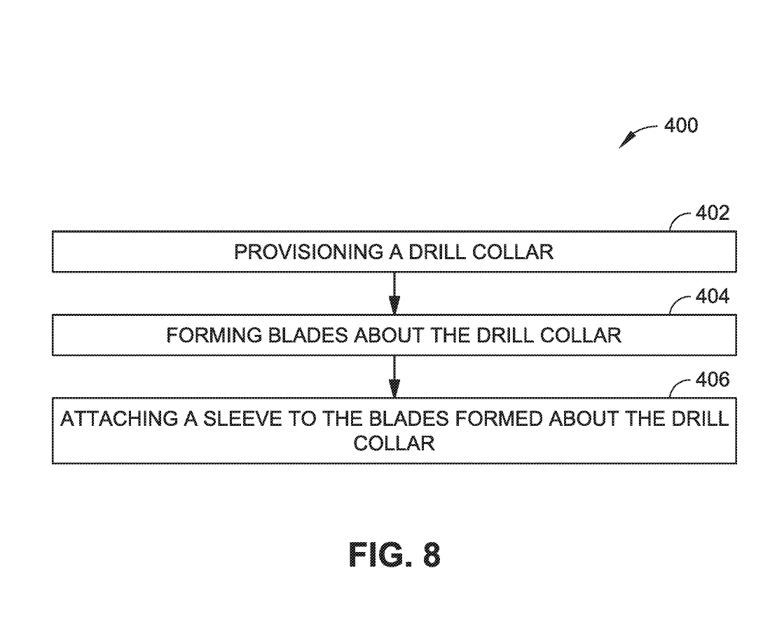

FIG. 8 is a flow diagram showing an example process 400 for producing a drilling stabilizer, such as the drilling stabilizer 300 described herein. In implementations, the process 400 can include the following operations (i.e., operations 402, 404, and 406), and may further include one or more operations related to manufacturing one or more features described in accordance with embodiments of the drilling stabilizer 300. The process 400 can include provisioning a drill collar (operation 402). For example, a drill collar (e.g., collar 306) may serve as a base structure of the drilling stabilizer. A plurality of blades (e.g., blades 302) are then formed on the drill collar (operation 404). For example, the blades can be welded to the drill collar or formed by a three-dimensional or additive manufacturing technology, such as three-dimensional printing, laser cladding, or the like. A sleeve (e.g., sleeve 304) can be formed over the blades (operation 406). For example, the sleeve can be welded onto the blades or otherwise attached thereto. In other implementations, the sleeve may be supported over the blades by one or more support members such that the blades can rotate independent of the sleeve. The sleeve can be arranged such that the blades are bound by a diameter of the sleeve (i.e., no portion of the blade extends outwards from the drill collar beyond the sleeve in a direction perpendicular to a longitudinal axis of the drill collar, e.g., as shown in FIG. 4). In some embodiments, however, portions of the blades may extend past the sleeve longitudinally (i.e., in a direction parallel to a longitudinal axis of the drill collar, e.g., as shown in FIG. 5).

Although a few example embodiments have been described in detail above, those skilled in the art will readily appreciate that many modifications are possible in the example embodiments without materially departing from a drilling stabilizer having a sleeve formed over its blades. Features shown in individual embodiments referred to above may be used together in combinations other than those which have been shown and described specifically. Accordingly, any such modification is intended to be included within the scope of this disclosure as defined in the following claims. In the claims, means-plus-function clauses are intended to cover the structures described herein as performing the recited function and not just structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A drilling stabilizer, comprising:
a drill collar configured to be removably coupled with a component of a drill string;
a plurality of blades disposed about the drill collar; and
a sleeve over the plurality of blades.

2. The drilling stabilizer as recited in claim 1, wherein the plurality of blades are coupled to the sleeve.

3. The drilling stabilizer as recited in claim 1, wherein the plurality of blades are partially exposed, wherein each exposed portion of the plurality of blades is bound by a diameter of the sleeve.

4. The drilling stabilizer as recited in claim 3, wherein exposed portions of the plurality of blades are tapered.

5. The drilling stabilizer as recited in claim 1, wherein the drill collar includes bearings.

6. The drilling stabilizer as recited in claim 1, wherein the sleeve includes openings formed on a lateral surface of the sleeve, the openings allowing fluid flow through or along the lateral surface of the sleeve.

7. The drilling stabilizer as recited in claim 6, wherein the openings comprise a plurality of holes or grooves.

8. The drilling stabilizer as recited in claim 1, wherein the sleeve comprises two or more disjoined portions, wherein at least one of the two or more disjoined portions is coupled to two or more blades.

9. The drilling stabilizer as recited in claim 1, wherein the plurality of blades comprise aerofoil-shaped blades.

10. The drilling stabilizer as recited in claim 1, wherein a thickness of a blade of the plurality of blades is less than a distance between the blade and a neighboring blade.

11. A drilling system, comprising:
a drill string;
a plurality of blades configured to rotate about a longitudinal axis of the drill string while the drill string is lowered into or raised out of a borehole; and
a sleeve over the plurality of blades, wherein the plurality of blades are bound by a diameter of the sleeve, the sleeve configured to form a barrier between the plurality of blades and an inner wall of the borehole.

12. The drilling system as recited in claim 11, wherein the plurality of blades are partially exposed, wherein exposed portions of the plurality of blades are tapered.

13. The drilling system as recited in claim 11, wherein the plurality of blades are formed on a drill collar.

14. The drilling system as recited in claim 13, wherein the drill collar is configured to be removably coupled with a component of the drill string.

15. The drilling system as recited in claim 13, wherein the drill collar includes bearings that enable the plurality of blades to rotate about the drill string or at a different rotational rate than the drill string.

16. The drilling system as recited in claim 11, wherein the sleeve includes openings formed on a lateral surface of the sleeve, the openings allowing fluid flow through or along the lateral surface of the sleeve.

17. A method of producing a drilling stabilizer, the method comprising:
provisioning a drill collar;
forming blades about the drill collar; and
attaching a sleeve to the blades formed about the drill collar.

18. The method of claim 17, wherein the blades are formed about the drill collar by welding.

19. The method of claim 17, wherein the blades are formed about the drill collar with a three-dimensional manufacturing technology, wherein material is gradually deposited on the drill collar.

20. The method of claim 19, wherein the three-dimensional manufacturing technology comprises laser cladding.
